(19) United States
(12) Patent Application Publication
(10) Pub. No.: US 2025/0128668 A1
(43) Pub. Date: Apr. 24, 2025

(54) HEAD-UP DISPLAY

(71) Applicant: HYUNDAI MOBIS CO., LTD., Seoul (KR)

(72) Inventor: Byung Ki KIM, Yongin-si (KR)

(73) Assignee: HYUNDAI MOBIS CO., LTD., Seoul (KR)

(21) Appl. No.: 18/894,545

(22) Filed: Sep. 24, 2024

(30) Foreign Application Priority Data
Oct. 24, 2023 (KR) 10-2023-0143001
Nov. 7, 2023 (KR) 10-2023-0152503

(51) Int. Cl. B60R 11/02; B60K 35/231; B60R 11/00

(52) U.S. Cl. CPC B60R 11/0235; B60K 35/231; B60R 2011/0052; B60R 2011/0092

(57) ABSTRACT

A head-up display comprising: a lower case; an aspherical mirror including at first and second ends thereof, a first spherical mount and a second spherical mount which are mounted in mounting grooves formed at first and second ends of the lower case; an upper module disposed at an upper portion of the aspherical mirror and coupled to the lower case, wherein the aspherical mirror includes a rigidity reinforcement portion located between the first spherical mount and the second spherical mount.

### CROSS-REFERENCE TO RELATED APPLICATION

This application claims the benefit of priority to Korean Patent Application No. 10-2023-0143001, filed on Oct. 24, 2023 in Korea, and Korean Patent Application No. 10-2023-0152503, filed on Nov. 7, 2023 the entire contents of which are incorporated herein by reference.

### TECHNICAL FIELD

The present disclosure relates to a head-up display.

### BACKGROUND

The content described in this section merely provides background information related to one embodiment of the present disclosure and does not constitute prior art.

A head-up display is fixed by pressing spherical mounts formed on both ends of an aspheric mirror using a screen and an elastomer. Specifically, when an external force is applied, the movement of the spherical mount is restricted by the screen. In this case, the movement range of the elastomer is also limited within the limited movement range. However, since the aspherical mirror moves within the elastic range of the elastomer, the spherical mount can be fixed without permanent deformation.

The aspherical mirror is formed based on a cantilever structure. As a result of measuring the stiffness of the aspherical mirror using Modal analysis, the stiffness of the aspherical mirror is interpreted to be lowest in the central area. In this case, Modal analysis is an analysis that finds the natural frequency and mode shape of a structure.

Even if the structure of the aspherical mirror is assumed to be a simple beam subjected to a uniformly distributed load, the maximum bending moment and maximum deflection are highest in the central area of the simple beam. Therefore, when external force is continuously applied to the central area of the aspherical mirror, problems such as breakage and bonding may occur.

### SUMMARY

In view of the above, one embodiment of the present disclosure provides a head-up display capable of increasing the rigidity of an aspherical mirror by using an elastomer in a rigidity reinforcement portion formed in a central area of the aspherical mirror.

The head-up display according to one embodiment can restrict the movement of a first spherical mount and a second spherical mount using a stopper formed in a mounting groove where the aspherical mirror is mounted.

Further, another embodiment of the present disclosure provides a head-up display apparatus capable of increasing the rigidity of an aspherical mirror by using a first elastomer and a second elastomer in a rigidity reinforcement portion formed in a central area of the aspherical mirror.

The head-up display according to another embodiment can restrict the movement of the first spherical mount and the second spherical mount using a stopper formed in a mounting groove where the aspherical mirror is mounted.

However, the objects to be achieved by the present disclosure are not limited to the objects mentioned above, and other objects not mentioned will be clearly understood by a person of ordinary skill in the art from the description below.

According to one embodiment, the head-up display can increase the rigidity of the aspherical mirror by using the elastomer in the rigidity reinforcement portion formed in the central area of the aspherical mirror.

According to one embodiment, the head-up display can restrict the movement of the first spherical mount and the second spherical mount using the stopper formed in the mounting groove where the aspherical mirror is mounted.

According to another embodiment, the head-up display apparatus can increase the rigidity of the aspherical mirror by using the first elastomer and the second elastomer in the rigidity reinforcement portion formed in the central area of the aspherical mirror.

According to another embodiment, the head-up display can restrict the movement of the first spherical mount and the second spherical mount using the stopper formed in the mounting groove where the aspherical mirror is mounted.

### BRIEF DESCRIPTION OF THE DRAWINGS

FIG. 1 is an exploded perspective view showing a head-up display according to one embodiment of the present disclosure.

FIG. 2 is a perspective view showing the head-up display excluding an upper module according to one embodiment of the present disclosure.

FIG. 3 is a perspective view showing an aspherical mirror according to one embodiment of the present disclosure.

FIG. 4 is a cross-sectional view taken along line A-A of FIG. 2.

FIG. 5 is a diagram showing a coupling relationship between a lower case and the aspherical mirror according to one embodiment of the present disclosure.

FIG. 6 is an exploded perspective view showing a head-up display apparatus according to another embodiment of the present disclosure.

FIG. 7 is a plan view showing the head-up display apparatus according to another embodiment of the present disclosure.

FIG. 8 is a cross-sectional view taken along line A-A of FIG. 7.

FIG. 9 is a diagram showing the operating state of a first elastomer and a second elastomer as the aspherical mirror according to another embodiment of the present disclosure rotates.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

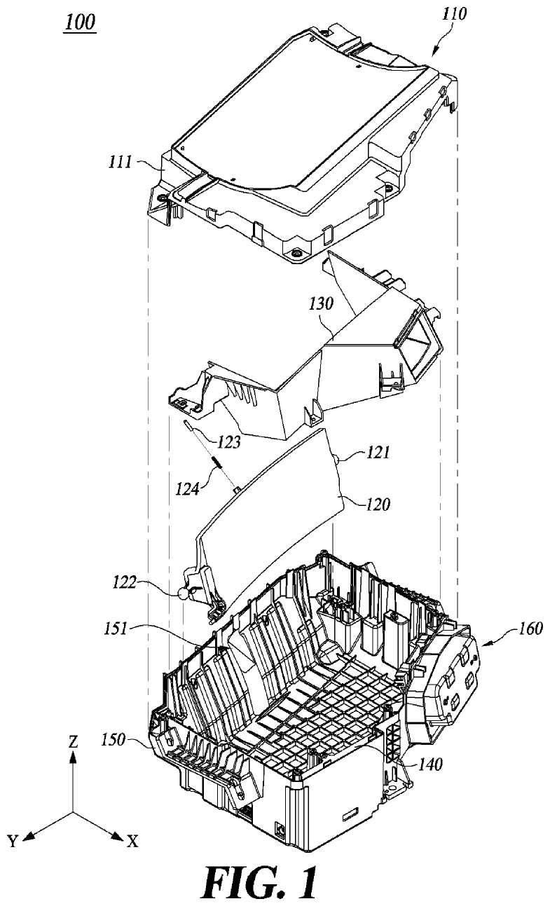

FIG. 1 is an exploded perspective view showing a head-up display according to one embodiment of the present disclosure.

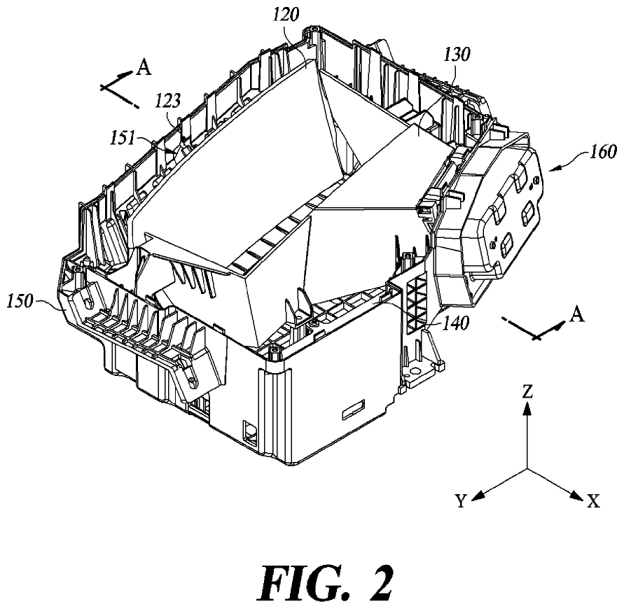

FIG. 2 is a perspective view showing the head-up display excluding an upper module according to one embodiment of the present disclosure.

Referring to FIGS. 1 and 2, the head-up display 100 includes some or all of an upper module 110, an aspheric mirror 120, a screen 130, a printed circuit board (PCB) 140, a lower case 150, and a picture generating unit 160.

The upper module 110 may be disposed at an upper portion of the head-up display 100. The upper module 110 may include a top case 111. Although not shown in FIG. 2, the upper module 110 may further include a cover lens (not shown). The cover lens may be secured to the top of the upper case 111.

The aspherical mirror 120 may include a first spherical mount 121 and a second spherical mount 122.

The aspherical mirror 120 may reflect display information projected from the picture generating unit 160 and irradiate it toward a windshield of a vehicle.

The aspherical mirror 120 is mounted to the lower case 150 to be rotatable. In this case, the first spherical mount 121 and the second spherical mount 122 may be mounted to the lower case 150.

The head-up display 100 is generally configured to reflect the display image projected from the picture generating unit 160 by the aspherical mirror 120 using a folding mirror (not shown), and display the image reflected by the aspherical mirror 120 on a windshield (not shown). However, the head-up display 100 may be configured to cause the picture generating unit 160 to project the display image directly onto the aspherical mirror 120 and display the display image reflected by the aspherical mirror 120 on the windshield.

It is desirable that the display location of the display information corresponding to a driver's eye height change when the driver's eye height changes. By appropriately rotating the aspherical mirror 120, the position of the display information where the image is reflected on the windshield can be adjusted.

The screen 130 may be coupled to the top of the aspherical mirror 120. The screen 130 may be coupled to the lower case 150 by screwing. When the screen 130 and the lower case 150 are coupled, the aspherical mirror 120 may be restricted from moving, for example, in a z-axis direction by the screen 130.

The screen 130 may guide the display image generated from the picture generating unit 160 toward the aspherical mirror 120.

The PCB 140 may be coupled inside the lower case 150.

The PCB 140 may be connected to a driving module (not shown) for rotating the aspherical mirror 120. The drive module may generate torque to rotate the aspherical mirror 120 using a motor.

The lower case 150 may be disposed at the bottom of the head-up display 100. The lower case 150 has an accommodation space for accommodating the PCB 140, the aspherical mirror 120, the screen 130, etc.

The lower case 150 includes a receiving portion 151.

The receiving portion 151 may receive a guide protrusion 123 that moves as the aspherical mirror 120 rotates. In this case, the guide protrusion 123 may be disposed at the rear of the aspherical mirror 120. The guide protrusion 123 may move in contact with one side surface of the receiving portion 151.

The picture generating unit 160 is formed on one side of the lower case 150. In FIG. 2, the picture generating unit 160 is shown as being disposed on a side surface of the lower case 150, but the present disclosure is not limited to thereto. The picture generating unit 160 may be disposed on a lower surface of the lower case 150.

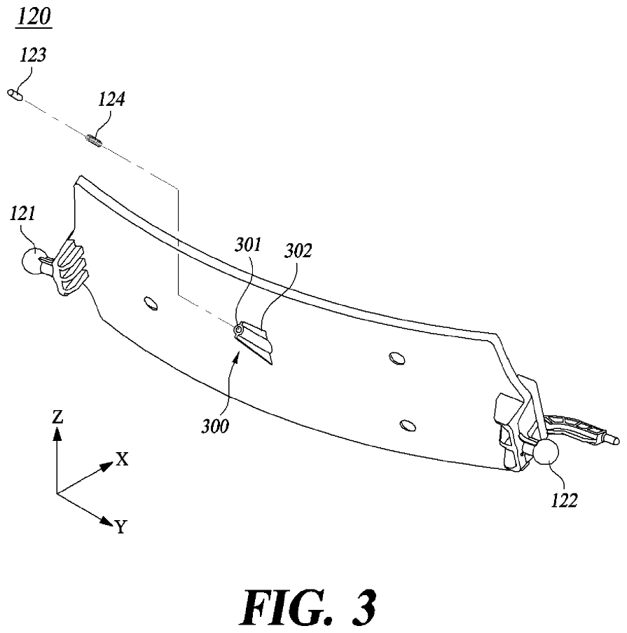

FIG. 3 is a perspective view showing the aspherical mirror 120 according to one embodiment of the present disclosure.

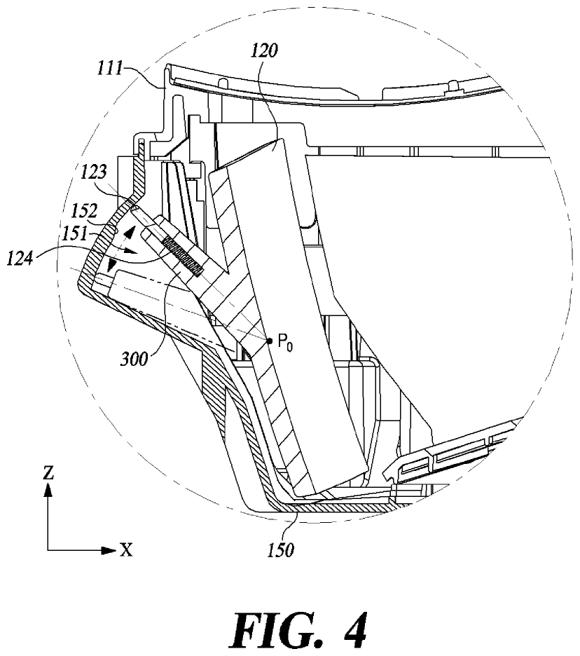

FIG. 4 is a cross-sectional view taken along line A-A of FIG. 2.

Referring to FIGS. 1 to 4, the aspherical mirror 120 according to one embodiment of the present disclosure includes a rigidity reinforcement part 300. The rigidity reinforcement part 300 is formed to protrude from a center area of the aspherical mirror 120.

The rigidity reinforcement part 300 may be formed to protrude from the rear of the aspherical mirror 120. In this case, the rear of the aspherical mirror 120 refers to the side opposite to the front of the aspherical mirror 120. The front of the aspherical mirror 120 refers to the surface on which the image of the head-up display 100 emitted from the picture generating unit 160 is reflected.

The rigidity reinforcement part 300 may have a cone shape whose diameter decreases as the distance from the aspherical mirror 120 increases. The rigidity reinforcement part 300 includes a plurality of ribs 302 on an outer surface thereof. The plurality of ribs 302 are formed to maintain the rigidity of the rigidity reinforcement part 300.

The rigidity reinforcement part 300 according to one embodiment of the present disclosure is shown to protrude upward from the rear of the aspherical mirror 120 in FIGS. 3 and 4, but the present disclosure is not limited thereto. The rigidity reinforcement part 300 according to another embodiment may be formed to protrude downward or laterally from the rear of the aspherical mirror 120.

The rigidity reinforcement part 300 has an accommodation groove 301 therein. The internal shape of the accommodation groove 301 may be cylindrical. However, the internal shape of the accommodation groove 301 is not limited to this.

An elastomer 124 and a guide protrusion 123 are accommodated in the accommodation groove 301. The diameters of the elastomer 124 and the guide protrusion 123 correspond to the diameter of the accommodation groove 301.

The elastomer 124 is completely inserted into the accommodation groove 301. The elastomer may be a spring.

The guide protrusion 123 may be partially inserted in the accommodation groove 301. The guide protrusion 123 partially protrudes from the accommodation groove 301 and contacts the guide groove 152 formed inside the lower case 150. When the aspherical mirror 120 rotates, the guide protrusion 123 may move along the guide groove 152. One end of the guide protrusion 123 that contacts the guide groove 152 may have a round shape.

The other end of the guide protrusion 123 is disposed in contact with the elastomer 124. When the displacement of the elastomer 124 has a negative or positive value, the position of the guide protrusion 123 changes in the accommodation groove 301. The guide protrusion 123 is disposed in contact with one of the guide grooves 152 formed within the receiving portion 151. When the aspherical mirror 120 rotates, the guide protrusion 123 can move while maintaining contact with the guide groove 152.

The guide groove 152 forms a first rotation section and a second rotation section.

The first rotation section refers to a section in which rotation of the aspherical mirror 120 does not occur frequently. That is, the first rotation section may mean the rotation section of the aspherical mirror 120 when the head-up display 100 is in an inactive state or is activated.

On the other hand, the second rotation section refers to a section in which rotation of the aspherical mirror 120 occurs relatively frequently. That is, the second rotation section may mean the rotation section of the aspherical mirror 120 when the driver is driving, based on the head-up display 100 being activated. Accordingly, the elastomer 124 is compressed and has a negative displacement so that a greater elastic force is generated in the second rotation section.

The second rotation section is formed by bending inward from the first rotation section.

In the first rotation section and the second rotation section, the guide groove 152 is formed, for example, in a “V” shaped groove so that the guide protrusion 123 rotates a certain section. When the aspherical mirror 120 rotates, the guide protrusion 123 moves in contact with the “V” shaped groove.

The aspherical mirror 120 may rotate by a first angle in the first rotation section. In this case, the first angle may be an angle of a section in which rotation of the aspherical mirror 120 does not occur frequently. For example, when the head-up display 100 is activated, the aspherical mirror 120 may be rotated in a section within the first angle.

The aspherical mirror 120 may rotate by a second angle in the second rotation section. In this case, the second angle may be an angle of a section where rotation of the aspherical mirror 120 occurs relatively frequently. For example, while the vehicle is driving, the head-up display 100 tracks the driver's eye-box in real time. The aspherical mirror 120 may be rotated within a second angular range corresponding to the driver's eye-box. This is because the driver's eye-box moves depending on the height of the seat, the angle of the backrest, the driver's posture, etc.

It is assumed that the elastic force of the elastomer 124 is, for example, F1 when the aspherical mirror 120 rotates within the first rotation section. In addition, it is assumed that the elastic force of the elastomer 124 is, for example, F2 when the aspherical mirror 120 rotates within the second rotation section. The elastic force F2 is greater than the elastic force F1. This is because the elastomer 124 is compressed more in the second rotation section than in the first rotation section. Since the second rotation section is formed by bending inward from the first rotation section, the guide protrusion 123 partially enters the accommodation groove 301 and compresses the elastomer 124. Accordingly, the elastic force of the elastomer 124 is greater when the aspherical mirror 120 rotates within the second rotation section than when the aspherical mirror 120 rotates within the first rotation section.

The head-up display 100 according to one embodiment of the present disclosure can reinforce the rigidity of the central area of the aspherical mirror 120 in the second rotation section in which the aspherical mirror 120 is frequently driven using the elastic force of the elastomer 124.

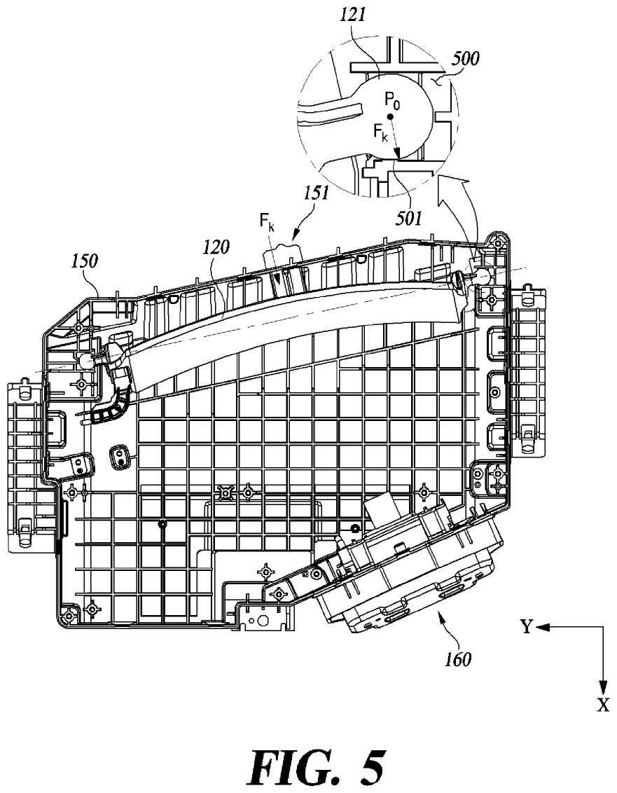

FIG. 5 is a diagram showing the coupling relationship between the lower case 150 and the aspherical mirror 120 according to one embodiment of the present disclosure.

Referring to FIGS. 4 and 5, the elastomer 124 applies an elastic force Fk to the aspherical mirror 120. The elastic force Fk applied from the elastomer 124 is transmitted to the mounting groove 500 based on a center point P0 of the first spherical mount 121.

The lower case 150 includes the mounting grooves 500 at both ends. While only the mounting groove 500 corresponding to the first spherical mount 121 is shown in FIG. 5, hereinafter, the mounting groove 500 in which the first spherical mount 121 is mounted can be applied for the description of the second spherical mount 122.

The mounting groove 500 may include a first mounting groove (not shown) and a second mounting groove (not shown). The first spherical mount 121 and the second spherical mount 122 may be mounted in the first and second mounting grooves, respectively.

The shape of the mounting groove 500 may be formed, for example, in a “V” shape to prevent clearance when coupled with the first spherical mount 121. However, the shape of the mounting groove 500 is not limited to this. For example, the shape of the mounting groove 500 is preferably formed so that the first spherical mount 121 can be mounted regardless of the tolerance of the lower case 150.

According to one embodiment of the present disclosure, the mounting groove 500 includes a stopper portion 501.

The stopper portion 501 may be formed integrally on one side of the mounting groove 500. However, the stopper portion 501 may be coupled or attached to the mounting groove 500 as a separate part.

The stopper portion 501 may restrict the movement of the aspherical mirror 120. For example, when the elastic force Fk of the elastomer 124 is applied to one side of the accommodation groove 301 based on the center point P0 of the first spherical mount 121, the aspherical mirror 120 may vibrate due to the elastic force Fk. In this case, the stopper portion 501 may restrict the movement of the aspherical mirror 120 in the direction in which the elastic force is applied to prevent the aspherical mirror 120 from vibrating.

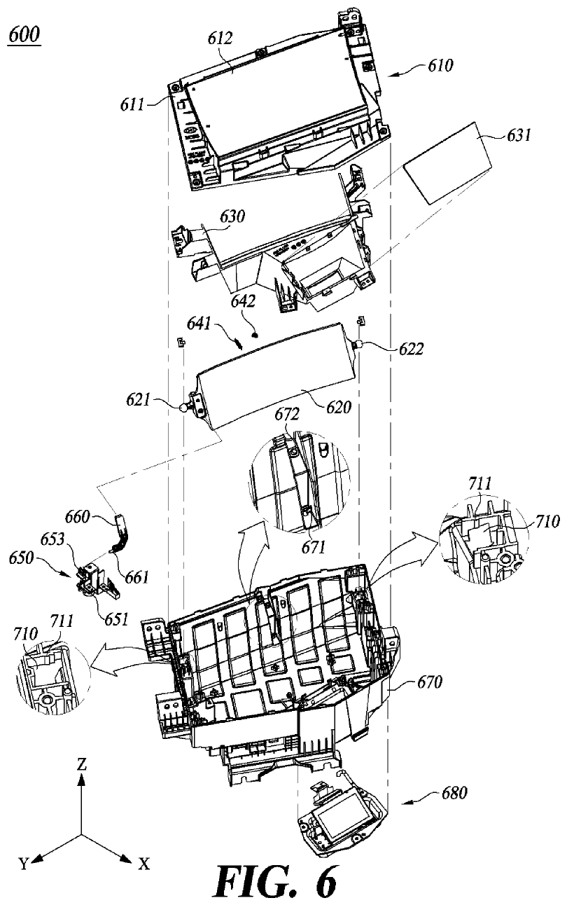

FIG. 6 is an exploded perspective view showing a head-up display apparatus according to another embodiment of the present disclosure.

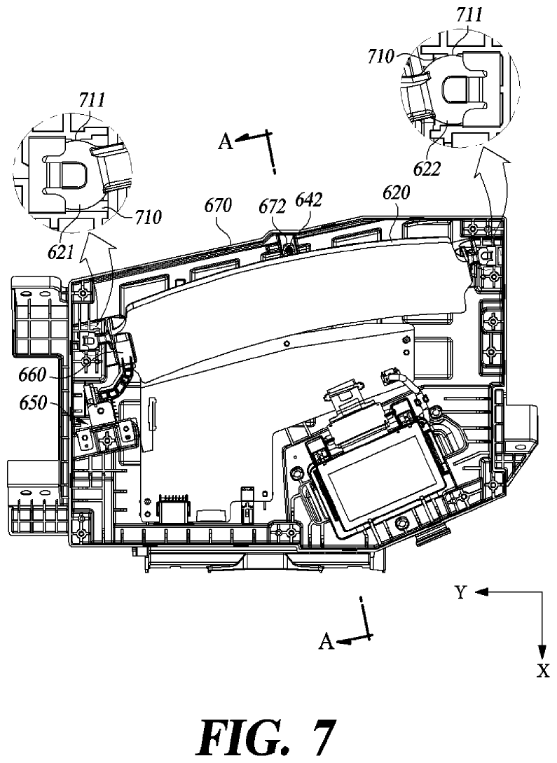

FIG. 7 is a plan view showing the head-up display apparatus according to another embodiment of the present disclosure.

Referring to FIGS. 6 and 7, the head-up display 600 according to another embodiment of the present disclosure includes some or all of an upper module 610, a screen 630, an aspheric mirror 620, a driving module 650, a lower case 670, and a picture generation unit 680.

The upper module 610 is disposed at an upper portion of the head-up display 600. The upper module 610 includes an upper case 611 and a cover lens 612. The cover lens 612 may be mounted on the top of the upper case 611. An adhesive may be applied between the cover lens 612 and the upper case 611 to generate bonding force.

The screen 630 may be coupled to an upper portion of the aspherical mirror 620. The screen 630 may be coupled to the lower case 670 by screwing. When the screen 630 and the lower case 670 are coupled to each other, the aspherical mirror 620 may be restricted from moving in the z-axis direction by the screen 630, for example.

A folding mirror 631 may be mounted on the top of the screen 630. The folding mirror 631 may guide the display image generated from the picture generating unit 680 toward the aspherical mirror 620.

The head-up display 600 according to another embodiment of the present disclosure may be, for example, a two mirror type. In this case, the two-mirror type refers to a head-up display type in which the display image generated from the picture generating unit 680 is reflected by two mirrors until it is projected onto the windshield. The head-up display 600 according to another embodiment of the present disclosure can project the display image toward the windshield using the folding mirror 631 and the aspherical mirror 620.

However, the heads-up display 600 according to another embodiments of the present disclosure may be configured such that the picture generating unit 680 projects the display image directly onto the aspherical mirror 620 and the display image reflected by the aspherical mirror 620 is displayed on the windshield.

The aspherical mirror 620 may include a first spherical mount 621 and a second spherical mount 622.

The aspherical mirror 620 may reflect the display information projected from the picture generating unit 680 and irradiate it to the windshield of the vehicle.

The aspherical mirror 620 is mounted inside the lower case 670 to be rotatable. In this case, the first spherical mount 621 and the second spherical mount 622 are mounted inside the lower case 670 so that the position of the aspherical mirror 620 can be determined.

The aspherical mirror 620 may include rigidity reinforcement parts 633 and 634. The rigidity reinforcement parts 633 and 634 may be formed at the rear of the aspherical mirror 620.

The rigidity reinforcement parts 633 and 634 include a first fitting portion 634 and a first engaging portion 633, which will be described later.

The rigidity reinforcement parts 633 and 634 may be formed by combining the first elastomer 641 and the second elastomer 642.

When the aspherical mirror 620 is mounted inside the lower case 670, the first elastomer 641 and the second elastomer 642 are disposed between the aspherical mirror 620 and the lower case 670.

The first elastomer 641 and second elastomer 642 are disposed in the center area, at the rear of the aspherical mirror 620, to reinforce the rigidity of the center area of the aspherical mirror 620 as the aspherical mirror 620 rotates.

Although not shown in FIGS. 6 and 7, the head-up display 600 may further include a PCB (not shown). The PCB may be coupled to the inside of the lower case 670.

The PCB may be connected to a driving module 650 for rotating the aspherical mirror 620.

The driving module 650 is connected between the lower case 670 and the aspherical mirror 620. The driving module 650 is configured to rotate the aspherical mirror 620.

The driving module 650 includes a step motor 151, a lead screw 652, and a link 653 to rotate the aspherical mirror 620.

The lead screw 652 is connected to the step motor 651 and converts the rotational motion of the step motor 651 into linear motion. However, the aspherical mirror 620 does not have to rotate in response to the driving command of the head-up display 600, and the driver may manually adjust the aspherical mirror 620 while viewing the height of the head-up display information.

The link 653 is connected between the aspherical mirror 620 and the lead screw 652 to allow the aspherical mirror 620 to rotate according to the driving of the step motor 651. For example, the link 653 moves up and down as the lead screw 652 rotates. In this case, a groove may be formed inside the link 653 so that a connection portion 660 can move in the left and right directions. The connection portion 660 has a locating pin 661 that protrudes a predetermined length in the y-axis direction and can move within the groove formed in the link 653.

Accordingly, if the driver's eye level changes due to a change in driver or seat height adjustment, for example, the head-up display 600 calculates a position of the head-up display information that matches the driver's eye level, and rotates the aspherical mirror 620 to display the head-up display information at the calculated position. The driver's eye level information may be manually entered by the driver, or may be automatically detected by an eye level detection device (not shown) separately provided in the vehicle.

The lower case 670 may be placed at the bottom of the head-up display 600. The lower case 670 has an accommodating space for accommodating the screen 630 and the aspherical mirror 620.

The lower case 670 includes a mounting groove 710 in which the aspherical mirror 620 is mounted. The mounting grooves 710 may be formed at both ends of the lower case 670 to correspond to the first and second spherical mounts 621 and 622 of the aspherical mirror 620, respectively.

The shape of the mounting groove 710 may be formed, for example, in a “V” shape to prevent clearance when each of the first spherical mount 621 and the second spherical mount 622 is mounted. However, the shape of the mounting groove 710 is not limited to this. For example, the shape of the mounting groove 710 is preferably formed so that each of the first spherical mount 621 and the second spherical mount 622 can be mounted regardless of the tolerance of the lower case 670.

The mounting groove 710 according to another embodiment of the present disclosure includes a stopper portion 711.

The stopper portion 711 may be formed on one side of the mounting groove 710. Specifically, the stopper portion 711 may be formed to protrude in the x-axis direction in the mounting groove 710. However, the stopper portion 711 may be coupled or attached to the mounting groove 710 as a separate part.

The picture generating unit 680 is formed on one side of the lower case 670. In FIGS. 6 and 7, the picture generating unit 680 is shown as being disposed at the lower side of the lower case 670, but present disclosure is not limited thereto. When the head-up display 600 is a one mirror type, the picture generating unit 680 may be disposed at a side surface of the lower case 670.

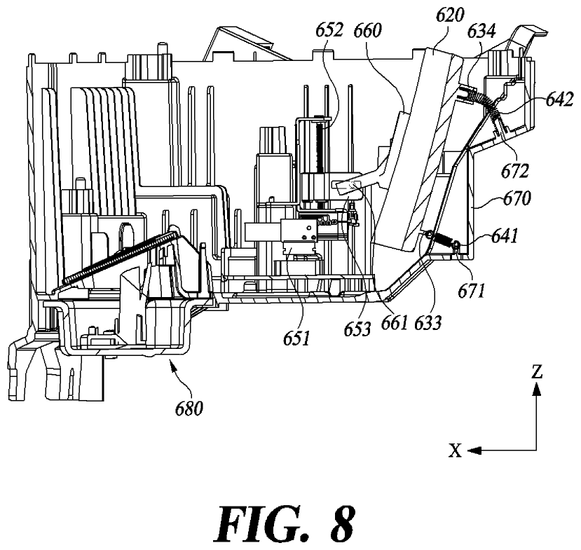

FIG. 8 is a cross-sectional view taken along line A-A of FIG. 7.

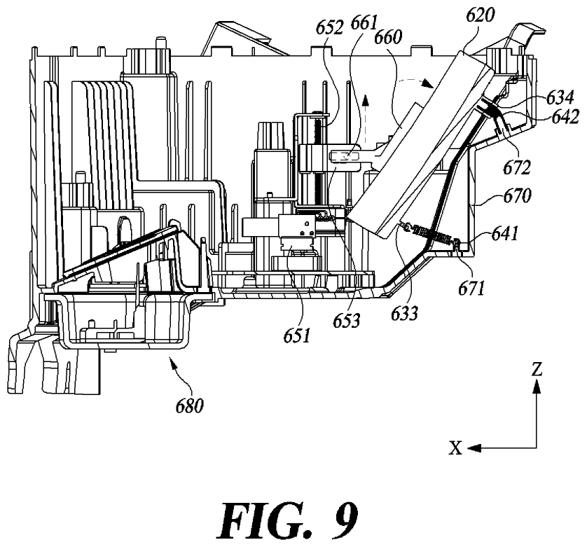

FIG. 9 is a diagram showing the operating state of the first elastomer and the second elastomer as the aspherical mirror according to another embodiment of the present disclosure rotates.

Referring to FIGS. 7 to 9, as the step motor 651 of the drive module 650 drives, the link 653 moves up and down along the lead screw 652. The locating pin 661 of the connection portion 660 can move left and right inside the groove of the link 653 as the link 653 moves up and down. That is, as the link 653 moves up and down the lead screw 652 and the locating pin 661 moves left and right, the aspherical mirror 620 can rotate. In the conventional head-up display apparatus, an elastomer that prevents clearance between units corresponding to the connection portion 660 and the link 653 is separately disposed therebetween. However, the head-up display 600 according to another embodiments of the present disclosure can eliminate clearance between the connection portion 660 and the link 653 using the first elastomer 641 and the second elastomer 642, even without disposing a separate elastomer between the connection portion 660 and the link 653.

The lower case 670 includes a second engaging portion 671 and a second fitting portion 672.

The second engaging portion 671 and the second fitting portion 672 are formed integrally in one area of the lower case 670. The second engaging portion 671 and the second fitting portion 672 are preferably formed in an area corresponding to a position where the aspherical mirror 620 is mounted inside the lower case 670.

The second engaging portion 671 may be formed in a hook shape so that the other end of the first elastomer 641 can be hooked. Alternatively, the second engaging portion 671 may have a predetermined hole formed so that a portion of the other end of the first elastomer 641 can be engaged.

The second fitting portion 672 has a groove formed so that the other end of the second elastomer 642 can be fitted, and a boss (not shown) is formed in the center of the formed groove. In this case, the boss is preferably formed to have a size corresponding to the diameter of the second elastomer 642.

The first elastomer 641 may be, for example, a tension spring. The first elastomer 641 refers to a spring that has a compressive force against the external force when stretched by an external force. As the aspherical mirror 620 rotates by a predetermined angle from its home position, the length of the first elastomer 641 increases. That is, the first elastomer 641 has a compressive force proportional to the rotation angle of the aspherical mirror 620.

The second elastomer 642 may be, for example, a compression spring. The second elastomer 642 refers to a spring that has a tensile force against the external force when compressed by an external force. As the aspherical mirror 620 rotates by a predetermined angle from the home position, the length of the first elastomer 641 decreases. That is, the second elastomer 642 has a tensile force proportional to the rotation angle of the aspherical mirror 620.

The first elastomer 641 and the second elastomer 642 can reinforce the rigidity of the central region of the aspherical mirror 620 based on given tensile force and compressive force, respectively, when the aspherical mirror 620 maintains the rotated state.

The second elastomer 642 according to another embodiment of the present disclosure may maintain a bent state at a predetermined angle as it is coupled to the first fitting portion 634 and the second fitting portion 672.

The stopper portion 711 may restrict the movement of the aspherical mirror 620. For example, when the repulsive force of the first elastomer 641 is greater than the repulsive force of the second elastomer 642, the aspherical mirror 620 may move in a direction opposite to the x-axis direction shown in FIG. 2. Therefore, as external force is applied to the first spherical mount 621 and the second spherical mount 622 in the direction opposite to the x-axis direction in the mounting groove 710, vibration and noise may occur. In this case, the stopper portion 711 can prevent vibration and noise by eliminating the clearance between the aspherical mirror 620 and the mounting groove 710.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A head-up display comprising:
a lower case;
an aspherical mirror including at first and second ends thereof, a first spherical mount and a second spherical mount which are mounted in mounting grooves formed at first and second ends of the lower case;
an upper module disposed at an upper portion of the aspherical mirror and coupled to the lower case,
wherein the aspherical mirror includes a rigidity reinforcement portion located between the first spherical mount and the second spherical mount.

2. The head-up display of claim 1, wherein the rigidity reinforcement portion is formed to protrude from a central area of the aspherical mirror.

3. The head-up display of claim 1, wherein the rigidity reinforcement part includes an accommodation groove in which an elastomer having a predetermined elastic force and a guide protrusion disposed at an end of the elastomer are accommodated.

4. The head-up display of claim 1, wherein the rigidity reinforcement part includes a plurality of ribs on an outer surface of the rigidity reinforcement part.

5. The head-up display of claim 3, wherein the lower case includes, on an inner surface of the lower case, a receiving portion for receiving a rotation radius of the rigidity reinforcement part, and as the aspherical mirror rotates, the guide protrusion moves in contact with an inner surface of the receiving portion.

6. The head-up display of claim 5, wherein the receiving portion includes a V-shaped groove on an inner surface of the receiving portion, and includes a guide groove formed by bending the inner surface of the receiving portion one or more times.

7. The head-up display of claim 6, wherein the guide groove includes:
a first rotation section in which the aspherical mirror rotates within a first angle range; and
a second rotation section in which the aspherical mirror rotates within a second angle range from the first rotation section.

8. The head-up display of claim 7, wherein the elastomer generates a greater elastic force in the second rotation section than in the first rotation section.

9. The head-up display of claim 1, wherein at least one of the mounting grooves include a stopper portion that restricts movement of the aspherical mirror due to an elastic force applied from the rigidity reinforcement part.

10. The head-up display of claim 9, wherein the stopper portion is formed or disposed on an inner surface of the at least one mounting groove at a position corresponding to a direction of the elastic force applied from the rigidity reinforcement part.

11. A head-up display apparatus comprising:
a lower case;
an aspherical mirror including:
a first spherical mount and a second spherical mount at first and second ends of the aspherical mirror and mounted inside the lower case; and
a rigidity reinforcement portion formed at a rear side of the aspherical mirror;
a driving module engaged to the aspherical mirror and configured to rotate the aspherical mirror;
a connection portion connected between the drive module and the aspherical mirror; and
a first elastomer and a second elastomer,
wherein the first elastomer and the second elastomer are coupled to the rigidity reinforcement portion to reinforce a rigidity of a central area of the aspherical mirror.

12. The head-up display apparatus of claim 11, wherein the rigidity reinforcement portion is formed integrally with the aspherical mirror.

13. The head-up display apparatus of claim 11, wherein the rigidity reinforcement part includes:
a first engaging portion to which a first end of the first elastomer is engaged; and
a first fitting portion to which a first end of the second elastomer is fitted.

14. The head-up display apparatus of claim 13, wherein the lower case includes:
a second engaging portion to which a second end of the first elastomer is engaged at a region corresponding to the first engaging portion based on the first elastomer; and
a second fitting portion to which a second end of the second elastomer is fitted at a region corresponding to the first fitting portion based on the second elastomer.

15. The head-up display apparatus of claim 14, wherein the second engaging portion and the second fitting portion are formed integrally with the lower case.

16. The head-up display apparatus of claim 14, wherein the second elastomer is configured to maintain a bent state while the first end of the second elastomer is coupled to the first fitting portion and the second end of the second elastomer is coupled to the second fitting portion.

17. The head-up display apparatus of claim 13, wherein a displacement of the first elastomer increases as the aspherical mirror rotates by a predetermined angle from a home position of the first elastomer, and the first elastomer has a compressive force proportional to a rotation angle of the aspherical mirror.

18. The head-up display apparatus of claim 13, wherein a displacement of the second elastomer decreases as the aspherical mirror rotates by a predetermined angle from a home position of the second elastomer, and the second elastomer has a tensile force proportional to a rotation angle of the aspherical mirror.

19. The head-up display apparatus of claim 11, wherein the driving module includes:
a motor that is configured to generate a driving force to rotate the aspherical mirror;
a lead screw extended and coupled to a rotation axis of the motor; and
a link that is engaged to the lead screw to move up and down on the lead screw and includes a groove,
wherein the connection portion includes a locating pin slidably engaged in the groove of the link and moving in the groove in a predetermined direction.

20. The head-up display apparatus of claim 19, wherein the first elastomer and the second elastomer provide elastic force to eliminate clearance that forms between the locating pin and the groove when the locating pin moves in the groove in the predetermined direction.
